(19) United States
(12) Patent Application Publication
(10) Pub. No.: US 2026/0265867 A1
(43) Pub. Date: Sep. 10, 2026

(54) Method For Recovering Rare Earths And Coproducts From Phosphogypsum And Phosphoric Acid Sludge

(71) Applicant: Universite Mohammed VI Polytechnique, Benguerir (MA)

(72) Inventors: Khaoula Khaless, El Jadida (MA); Hamza Chanouri, Souk Sebt Oulad Nemma (MA); Rachid Benhida, Nice (FR)

(73) Assignee: Universite Mohammed VI Polytechnique, Benguerir (MA)

(21) Appl. No.: 19/162,314

(22) PCT Filed: Mar. 15, 2024
(86) PCT No.: PCT/MA2024/050009

§ 371 Date: Sep. 4, 2025

(30) Foreign Application Priority Data
Mar. 16, 2023 (EP) 23305363.6

(51) Int. Cl. C22B 59/00; C01B 33/20; C01D 5/16; C01F 11/38; C22B 3/06; C22B 3/12; C22B 3/22; C22B 3/44

(52) U.S. Cl. CPC C22B 59/00; C01B 33/20; C01D 5/16; C01F 11/38; C22B 3/065; C22B 3/12; C22B 3/22; C22B 3/44

(57) ABSTRACT

A method for recovering rare earths from phosphogypsum or phosphoric acid sludge involves treating the material by washing the phosphogypsum with a polar solvent or separating the sludge into liquid and solid phases followed by washing the solid residue with a polar solvent at room temperature and then with a hot polar solvent, collecting the solid residues and liquid phases after each step. The final solid residue is dried, ground, and sieved, then subjected to alkaline leaching with a strong inorganic base, followed by collection of the solid residue and liquid phase. This residue is again dried, ground, and sieved, then acid leached with nitric acid to yield a solid residue and liquid phase. Calcium nitrate crystals are precipitated from this liquid phase, and the remaining liquid phase's pH is adjusted to between 1 and 1.8 using a strong base, producing a solid residue that is dried to obtain a product containing rare earths.

### TECHNICAL FIELD

The invention concerns a method for treating phosphogypsum and phosphoric acid sludge allowing the recovery of rare earths. More particularly, the present invention concerns a method allowing overall recovery of the various high added value by-products present in phosphogypsum or phosphoric acid sludge to move towards zero discharge.

### STATE OF THE ART

Rare earth elements (REEs) constitute a set of 17 metallic elements, i.e., lanthanides plus yttrium and scandium.

Rare earths and their alloys are of particular interest since their physicochemical properties make them materials of choice in various applications such as optics (lighting, radiography), mechanics due to their high hardness, or even magnetism (manufacture of permanent magnets).

Given the growing demand for REEs, the sustainable supply of REEs has become an important economic and strategic issue.

Thus, to overcome the overexploitation of primary resources, it is becoming urgent to substitute the recovery of REEs from primary ores with their recovery from secondary ores or industrial by-products, especially in countries where resources are dwindling or non-existent.

Currently, the development of a method for recovering REEs from industrial by-products that is clean, sustainable, economically reliable and that meets the principle of green chemistry is of capital urgency. Non-exhaustive examples of industrial by-products that can be exploited include phosphate by-products such as phosphogypsum (PGs) and phosphoric acid sludge (PASs).

The management of by-products from the phosphate industry is a major ecological and economic issue for the years ahead. Indeed, natural phosphate processing industries generate by-products containing high added value elements, such as REEs, P₂O₅ and fluorides, etc. which could be exploited at lower cost while preserving natural resources.

In this context, phosphoric acid sludge (PASs) and phosphogypsums (PGs) represent an essential alternative to meet the intensive market demand, particularly in REEs.

PG is the by-product resulting from the wet process of manufacturing 29% P₂O₅ phosphoric acid by attacking natural calcium phosphates, apatites, with concentrated sulfuric acid, according to reaction (1).

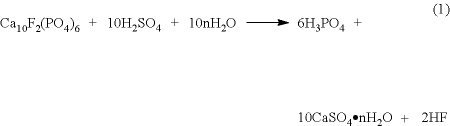

In general, PG occurs as a fine, moist, aggregated powder, consisting mainly of a gypsum dihydrate phase CaSO₄·2H₂O.

PASs are the by-product, precipitate, resulting from the evaporation/concentration of phosphoric acid from 29% to 54% P₂O₅ [1].

PASs come in the form of a pasty sludge, with two phases: an anhydrous gypsum solid phase CaSO₄ and a liquid phase of 54% P₂O₅ phosphoric acid. Silicates, REEs, aluminum, iron, fluorine, etc. are minor phases present in PASs at fairly high concentrations compared to PG. It is known that phosphate ores contain varying contents of valuable elements, i.e., REEs, fluorides, silicates, etc. In most cases, these elements are concentrated in the PG and PASs. In the case of the dihydrate method, 55 to 66% of REEs co-precipitate with PG when the phosphates are attacked by concentrated sulfuric acid [2]. The concentration of REEs in PGs and PASs, resulting from the transformation of sedimentary phosphate ores, is less than 0.1 and 0.22%, respectively [3], [4].

Many methods have been developed to recover the gypsum phase for further use in the construction industry and, to a lesser extent, to recover REEs [5].

Among the methods existing in the literature, document CN111560521A describes a method for acid leaching of a PG by a solution containing 20% by weight sulfuric acid, in the presence of an additive, amino trimethylene phosphonic acid at 0.002% by weight or hydroxyethylidene diphosphonic acid at 0.0015% by weight or polyethylene glycol 400 at 0.006% by weight. The PG treatment was carried out with a liquid to solid ratio of 10:1 at 100° C. and 50 revolutions per minute (rpm) for a reaction time of 12 h. After separation, the solid phase was washed with boiling water. This method allows the production of alpha-hemihydrate gypsum with a REE leaching rate greater than 90% [6].

Application CN112408452A describes a method for extracting REEs combined with purifying PG. High leaching of REEs was achieved by treating PG with a solution of composition: 4% by weight of nitric acid, 25% by weight of glycerol-butanol (the mass ratio of glycerol to butanol is 3:1), 8% by weight potassium nitrate and 2.5*10⁻² mol/Kg of an additive composed of maleic acid, sodium maleate and Al(NO)₃ in a molar ratio of 2:8:1. The suspension of the mixture of the prepared solution and PG (liquid-solid ratio 10:1) is poured into a three-necked round-bottom flask for heating in an oil bath at 95° C. under a stirring speed of 50 rpm for 6 h. After filtration, the solid phase is washed twice with boiling water and then with acetone. The leaching rate of rare earths reaches 97.3% and the obtained gypsum is of high strength [7].

Application WO 2020/067856 A1 demonstrates that acid leaching of a PG pre-washed with a potassium sulfate solution, using 2 N nitric acid, for 6 hours, in the presence of a potassium chlorate oxidizing agent to promote the dissolution of the REEs, and a zinc powder-type reducing agent to minimize the leaching of impurities, allows the production of a RE leachate containing a concentration of 179 ppm. The PG to acid weight ratio is 4:6 and the quantity of potassium chlorate and zinc is, respectively, 10 g/kg, 5 g/kg relative to the leaching mixture. Post-treatment of the leachate by evaporation promotes the increase in REE concentration to 260 ppm [4].

In addition to acid leaching, other purification techniques can be implemented.

Magnetic separation also allows high purification of PG. According to application CN110918251A, after separation of impurities, the purified PG is centrifuged to remove residual water. The main elements removed are: phosphorus impurities (95-97%), fluorine impurities (82-92%), organic impurities (80-90%), heavy metal oxides and radioactive metal impurities (70-87%). The recovery rate of REEs varies between 70 and 83% [8].

Other methods describe the purification of PGs using basic solutions.

The use of a 25% ammonium sulfate solution at a temperature above 92° C. for a duration varying from 10 to 20 min and a solid-liquid ratio varying from 1-5 to 1-20 is thus described [9].

Application RU2739409C1 [10] describes a leaching-precipitation method for REEs. First, 100 g of PG is leached for 6 h in 193.7 g of ammonium carbonate at a temperature of 40-55° C., according to the following reaction:

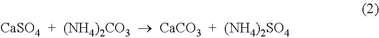

The second step consists of dissolving 65 g of the calcium carbonate obtained in 58% nitric acid at a stoichiometry of 120, 130 or 150%. After filtration, to remove insoluble compounds, the leaching liquor is cooled to between −10 and −15° C. to crystallize the calcium nitrate tetrahydrate. After separation of the calcium nitrate, the leachate is neutralized with lime, ammonia or lime water to a pH ranging from 0.7 to 1.3. The obtained precipitate contains 16% of RE oxides (REOs) [10].

It is also known from patent RU 2258036 C1 [11], that the treatment of PG with sodium carbonate at a concentration of 2.0-2.5 mol/L at 60-80° C. for 30-45 min, with a liquid to solid ratio of 2.0:2.5 promotes the precipitation of calcium carbonate rich in REEs.

The precipitated calcium carbonates are then transformed into calcium oxide CaO by calcination at 900-950° C. Then the calcium oxide undergoes solubilization with ammonium chloride to produce calcium chlorides and an insoluble precipitate rich in REEs. The precipitate is leached by a mixture of 5-6% hydrochloric acid and ascorbic acid at 80-90° C. for 30 to 60 minutes; the weight ratio of ascorbic acid to REEs is (0.4 to 0.5):1. The obtained solid phase contains 30-32% strontium, recovered as a commercial product and the leachate neutralized with ammonia at a pH of 9.0-9.5 allows the precipitation of REEs. The precipitate is post-treated with a sodium sulfate solution of pH comprised between 0.3 and 0.5 at 80-90° C. for 60-90 min to produce a mixed precipitate containing calcium sulfate and REEs.

Generally, the conversion of PGs with sodium carbonates, ammonium carbonates, etc. leads to the generation of carbon dioxide in the subsequent steps of REE recovery, which is a major limitation of these methods. Accordingly, there is the need to develop a green conversion technique that is more environmentally friendly.

It is also known from application EP 0419318 A1 [12] that the solubilization of PG with a saline solution containing 25 g/L of sodium chloride, followed by pretreatment of the insoluble residues rich in REEs with a solution of sodium bicarbonate then concentrated nitric acid promotes the dissolution of the REEs. However, this method consumes water, e.g., the treatment of one (1) kg of PG requires 200 liters of water, and results in the release into the natural environment of large quantities of saline water including fluorides, sulfates, chlorides, etc.

Another method is based on the leaching of PASs with nitric acid of concentration 7.2 mol/L previously heated to 72° C., for 1 h for an acid to PAS ratio of 4:1 under stirring at 400 rpm. This technique allows the leaching of 58.1% of REEs [13].

However, the prior art methods are mainly focused on the recovery of the gypsum phase and on the extraction of REEs and do not seek to individually isolate the other valuable elements in order to then recover them.

Furthermore, none of the documents presented deal with the recovery of the valuable elements (e.g. fluoride, silica, etc.) in PASs.

From an industrial viewpoint, there remains a need to provide a method for extracting and recovering rare earths, as well as valuable elements such as phosphorus, fluorine, silicon, calcium or sulfur contained in PG and REEs, which is as environmentally friendly as possible.

### BRIEF DESCRIPTION OF THE INVENTION

The present invention relates to a method for treating phosphogypsum or phosphoric acid sludge allowing the recovery of rare earths, the method comprising the following successive steps:
(a) treating the phosphogypsum or phosphoric acid sludge, respectively, according to the following steps (a1) or (a2):
   (a1) washing the phosphogypsum with a polar solvent and collecting the solid residue obtained; or
   (a2) separating the phosphoric acid sludge into a liquid phase and a solid residue and separately collecting the solid residue obtained and the liquid phase obtained;
      washing the solid residue obtained at the end of the treatment with a polar solvent at room temperature and separately collecting the solid residue obtained and the liquid phase obtained; and
      washing the solid residue obtained at the end of washing with a hot polar solvent and collecting the solid residue obtained and the liquid phase obtained;
(b) drying, grinding and sieving the solid residue obtained at the end of step (a);
(c) alkaline leaching the solid residue obtained at the end of step (b) with a strong mineral base, and collecting the solid residue obtained and the liquid phase obtained;
(d) drying, grinding and sieving the solid residue obtained at the end of step (c);
(e) acid leaching the solid residue obtained at the end of step (d) with nitric acid and collecting the solid residue obtained and the liquid phase obtained;
(f) precipitating calcium nitrate crystals from the liquid phase obtained at the end of step (e) and collecting the solid residue and the liquid phase obtained;
(g) adjusting the pH of the liquid phase obtained at the end of step (f) to a value of between 1 to 1.8 by adding a strong base and collecting the solid residue obtained and the liquid phase obtained;
(h) drying the solid residue obtained at the end of step (g) to obtain a solid product containing rare earths.

Other aspects of the invention are as described below and in the claims.

### DESCRIPTION OF THE FIGURES

FIG. 1 shows a block diagram of an exemplary embodiment of the invention.

FIG. 2 shows the evolution of the P₂O₅ concentration in the filtrates (denoted F1 to F6), i.e. the liquid phases, as a function of the number of cold washes during step (a) according to Example 1.

FIG. 3 shows the X-ray diffractogram of the solid residue (denoted B2) obtained at the end of the cold washes and of the solid residue (denoted B4) obtained at the end of step (b) according to Example 1.

FIG. 4 shows the X-ray diffractogram of the solid residue (denoted R2) obtained at the end of step (d) according to Example 1.

FIG. 5 shows the X-ray diffractogram of the precipitated sodium fluorosilicate (denoted C1) resulting from the cooling of the liquid phase obtained at the end of step (b) according to Example 1.

FIG. 6 shows the X-ray diffractogram of the sodium fluorosilicate (denoted C2) resulting from the treatment of the liquid phase obtained at the end of step (a) cooled and separated from the precipitated crystals and treated with a NaCl solution (A) or an Na₂CO₃ solution (B).

FIG. 7 shows the X-ray diffractogram of the sodium sulfate (denoted C3) obtained by neutralizing the liquid phase obtained at the end of step (c) then drying it and grinding the solid residue.

### DEFINITIONS

The term “rare earths” refers to the rare earth elements called lanthanides having atomic numbers from 57 to 71 inclusive, yttrium with atomic number 39 and scandium with atomic number 21.

The expression “room temperature” refers to, within the meaning of the present invention, a temperature comprised in a range from 20° C. to 25° C. When a step of the method according to the invention is carried out “cold”, it is understood that it is carried out at room temperature according to the definition above. The two terms are interchangeable.

The term “hot wash” refers to a washing operation at a temperature higher than room temperature as defined above and at a temperature below the boiling point (T_{bp} in ° C.) of the polar solvent used for the washing operation. Advantageously, the temperature of the hot polar solvent is (T_{bp}−40° C.) to (T_{bp}−10° C.), preferably (T_{bp}−20° C.) to (T_{bp}−10° C.).

The term “phosphogypsum” refers to a by-product of the wet production of phosphoric acid, i.e. obtained by reaction between fluorophosphate calcium ores and sulfuric acid. Such phosphogypsum is also called LREC phosphogypsum, which stands for “low rare earth case”. More generally, a phosphogypsum comprises from 26% to 40% of CaO, from 30% to 60% of SO₃, less than 3% SiO₂, less than 2% of P₂O₅, less than 2% of F, and 0.01% to 0.1% rare earth elements.

The term “phosphoric acid sludge” refers to the by-product obtained during a step of concentration of phosphoric acid obtained by the wet process, that is to say obtained by reaction between fluorophosphate calcium ores and sulfuric acid. The concentration step is preferably carried out so as to obtain phosphoric acid at a mass content ranging from 50% to 54% P₂O₅. Phosphoric acid sludge is also referred to as HREC phosphogypsum, which stands for “high rare earth case”. More generally, phosphoric acid sludges comprise from 22% to 30% of CaO, from 25% to 35% of SO₃, less than 2% of SiO₂, from 25% to 45% of P₂O₅, less than 2% of F, and from 0.1% to 0.4% of rare earth elements (% expressed by weight).

The term “leaching” within the meaning of the present invention means the extraction of a soluble compound from a solid residue by means of washing operations. When washing with a basic solution, it will be referred to as “alkaline leaching”, while it will be referred to as “acid leaching” when washing with an acidic solution.

The term “liquid phase” within the meaning of the present invention refers to a solution isolated from a solid residue by any step of separation of the liquid phase from the solid residue.

Unless otherwise indicated, the ratios indicated in the present application are mass ratios and the percentages are mass percentages.

### DETAILED DESCRIPTION OF THE INVENTION

The inventors have thus developed a method for recovering rare earths from phosphogypsum or phosphoric acid sludge. In addition to rare earths, the method according to the invention makes it possible to collect and recover the phosphorus, fluorine, silicon, calcium and sulfur (collectively referred to as co-products) contained in PG and PASs.

The proposed method is simple to implement and makes it possible to recover the co-products while being respectful of the environment.

The invention concerns a method for treating phosphogypsum or phosphoric acid sludge allowing the recovery of rare earths. The method comprises the following successive steps:
(a) treating the phosphogypsum or phosphoric acid sludge, respectively, according to the following steps (a1) or (a2):
   (a1) washing the phosphogypsum with a polar solvent and collecting the solid residue obtained; or
   (a2) separating the phosphoric acid sludge into a liquid phase and a solid residue and separately collecting the resulting solid residue and the resulting liquid phase;
      washing the solid residue obtained at the end of the separation with a polar solvent at room temperature and separately collecting the solid residue obtained and the liquid phase obtained; and
      washing the solid residue obtained at the end of washing with a hot polar solvent and collecting the solid residue obtained and the liquid phase obtained;
(b) drying, grinding and sieving the washed solid residue obtained at the end of step (a);
(c) alkaline leaching the ground residue obtained at the end of step (b) with a strong mineral base, and separately collecting the ground solid residue obtained and the liquid phase obtained;
(d) drying, grinding and sieving the solid residue obtained at the end of step (c);
(e) acid leaching the solid residue obtained at the end of step (d) with nitric acid and separately collecting the solid residue obtained and the liquid phase obtained;
(f) precipitating calcium nitrate crystals from the liquid phase obtained at the end of step (e) and separately collecting the solid residue and the liquid phase obtained;
(g) adjusting the pH of the liquid phase obtained at the end of step (f) to a value of between 1 to 1.8 by adding a strong base and collecting the solid residue obtained and the liquid phase obtained;
(h) drying the solid residue obtained at the end of step (g) to obtain a solid product containing rare earths.

The steps of the method of the invention may be as described in detail below.

The method of the present invention advantageously makes it possible to isolate and thus to recover other elements contained in phosphogypsum and PASs when one or more of the optional steps described below are carried out (e.g. phosphorus pentoxide, sodium fluorosilicate, calcium nitrate, sodium or ammonium nitrate, sodium sulfate).

The method can be carried out from phosphogypsum or PASs.

Steps (a) and (b) reduce the content of soluble impurities in the phosphoric acid sludge or phosphogypsum.

### Step (a)

When the method is carried out from phosphogypsum, step (a) is a step of treating the phosphogypsum by washing the phosphogypsum with a polar solvent (step (a1))

The phosphogypsum washing step removes impurities from the wet phosphoric acid manufacturing process such as organic matter, as well as traces of P₂O₅ and macroscopic impurities, so as to avoid enrichment in the rest of the method. This step also concentrates the REEs.

The polar solvent is preferentially water, methanol, ethanol, acetone, an ether or a mixture thereof.

When the polar solvent is an ether, it can be a petroleum ether, diethyl ether or diisopropyl ether.

Advantageously, the polar solvent is water.

The polar solvent can be used at room temperature or hot, preferentially at room temperature, which is more advantageous from an economic viewpoint.

The phosphogypsum is washed, by way of example, with gentle stirring for 5 min, the solid and the polar solvent being mixed in a solid to liquid mass ratio of 1:1.

The phosphogypsum washing operation can be carried out in cascade, i.e. the solid obtained at the end of a washing operation is then isolated and undergoes a new washing operation with the polar solvent.

The solid to liquid mass ratio can vary from 1:1 to 1:5 for these subsequent washing operations.

The washing time is generally from 1 to 15 minutes, preferentially from 5 to 10 minutes.

The phosphogypsum washing operation can thus be carried out several times until the liquid phase separated from the solid residue no longer contains P₂O₅ or only contains trace amounts.

The measurement of the conductivity of the liquid phase is representative of the presence of P₂O₅. Advantageously, the phosphogypsum washing operation is thus carried out until the conductivity value of the liquid phase is stabilized at a value of 2.35 mS/cm. Advantageously, the washing operation is conducted twice.

Washing allows the residual phosphoric acid in the isolated liquid phases to be recovered and eliminated.

When the method is carried out from phosphoric acid sludge, step (a) is a step of treating phosphoric acid sludge (a2) comprising:
separating the phosphoric acid sludge into a liquid phase and a solid residue and separately collecting the solid residue obtained and the liquid phase obtained;
washing the solid residue obtained at the end of the separation with a polar solvent at room temperature and separately collecting the solid residue obtained and the liquid phase obtained; and
washing the solid residue obtained at the end of washing with a hot polar solvent and collecting the solid residue obtained and the liquid phase obtained.

Several separation techniques can be used to separate the phosphoric acid sludge into a liquid phase (phosphoric acid with a mass content ranging from 45% to 54% P₂O₅) and a solid residue. The separation can be carried out by decantation, by vacuum filtration or by centrifugation, most particularly by centrifugation.

The solid residue obtained comprises calcium sulfate (CaSO₄), sodium fluorosilicate (Na₂SiF₆), residual P₂O₅, REEs and other metallic elements (see Table 1 in the experimental section).

The residue obtained is then washed at room temperature with a polar solvent.

Washing allows the residual P₂O₅ to be recovered and the impurities to be removed in order to concentrate the REEs.

The polar solvent used during washing of the solid residue may be a protic polar solvent or an aprotic polar solvent. The polar solvent is preferentially water, methanol, acetone, ethers or a mixture thereof. Generally, the polar solvent is water.

The contact time during washing at room temperature, preferably carried out with stirring, generally varies from 1 to 15 min, preferably from 5 to 10 min.

At the end of washing with the polar solvent at room temperature, the solid residue obtained and the liquid phase obtained are collected separately. “Collected separately” means that the solid residue and the liquid phase are separated and then individually collected. The separation can be carried out by vacuum filtration.

Washing at room temperature can be a cascade wash, i.e., several successive washes can be carried out, for example 2, 3, 4, 5 or 6 washes. Successive washes can be carried out with the same polar solvent.

Advantageously, the washes are carried out with increasing liquid/solid mass ratios, typically ranging from 1:1 to 5:1 or 10:1. This optimizes the recovery of P₂O₅.

The washing operation can be repeated until the liquid phase separated from the solid residue no longer contains P₂O₅ or only trace amounts, i.e. less than 0.52%.

The solid residue thus obtained after washing at room temperature with the polar solvent comprises calcium sulfate, sodium fluorosilicate, REEs and other metallic elements.

After washing at room temperature, the solid residue is washed with a hot polar solvent. Since the solubility of the sodium fluorosilicate is increased in the hot polar solvent, the hot washing step makes it possible to reduce the sodium fluorosilicate content (Na₂SiF₆) in the solid residue.

The polar solvent used may be the same as the one used for washing at room temperature or may be different. Typically, the polar solvent is water. In some embodiments, room temperature washing and hot washing are carried out with water. Typically, hot washing is carried out at a temperature ranging from 60° C. to 100° C., preferably from 80° C. to 90° C. when the polar solvent is water.

Hot washing with the polar solvent is typically carried out with a liquid to solid mass ratio ranging from 5:1 to 15:1, preferably from 10:1 to 15:1.

The contact time during hot washing, preferably carried out with stirring, generally varies from 5 to 20 min, preferably from 10 to 15 min.

The solid residue can be separated from the liquid phase by vacuum filtration.

The solid residue obtained from the hot wash comprises calcium sulfate, REEs and other metallic elements (see Table 1 in the experimental section). It has a reduced sodium fluorosilicate content.

Fluorine and silicon are recovered in the liquid phase, mainly in the form of sodium fluorosilicate.

### Step (b)

Step (b) is a step of drying, grinding and sieving the washed solid residue obtained at the end of step (a), whether this step is carried out from phosphogypsum or phosphoric acid sludge.

The washed solid residue is typically dried at a temperature ranging from 60 to 80° C.

Grinding reduces the particle size of the residue to facilitate the treatment of the residue in step (c) of the method.

The ground solid residue is typically sieved through a mesh of 250 μm and the fraction of less than 250 μm is collected. The ground and sieved residue is then typically in the form of particles having a size less than or equal to 250 μm, preferably ranging from 100 to 250 μm.

### Optional Step of Treating the Liquid Phase Obtained in Step (a)

When the method is carried out from phosphoric acid sludge, the method may comprise a step of crystallizing/precipitating the fluorosilicate salts, mainly in the form of sodium fluorosilicate, contained in the liquid phase obtained at the end of step (a) and collecting the salts obtained. Crystallization/precipitation of fluorosilicate salts can be obtained by cooling the liquid phase obtained at the end of step (a) to room temperature.

The sodium fluorosilicate crystals precipitated after cooling to room temperature can be isolated from the liquid phase. One or more sodium salts, preferably sodium chloride (NaCl) or sodium carbonate (Na₂CO₃), particularly preferably sodium chloride, can be added to the liquid phase (filtrate) saturated with fluorine, silicates and sodium to precipitate the residual fluorosilicate salts, which can then be isolated. Sodium chloride (NaCl) is particularly preferred because it makes it possible to obtain fluorosilicate salts having a purity greater than 96%, typically ranging from 96 to 99%.

Steps (c) to (f) make it possible to concentrate and leach the REEs.

### Step (c)

Step (c) is a step of alkaline leaching the solid residue (dried, ground and sieved) obtained at the end of step (b). The leaching is carried out by means of a strong mineral base, preferentially a solution of sodium hydroxide (NaOH), potassium hydroxide (KOH), lithium hydroxide (LiOH) or rubidium hydroxide (RbOH), particularly preferably a solution of sodium hydroxide.

When the strong base is a sodium hydroxide solution, the sodium hydroxide is typically present in the solution at a concentration varying from 5 to 7 mol/L, preferably at a concentration of 5.4 to 6.2 mol/L. The mass ratio of sodium hydroxide solution to the solid residue obtained at the end of step (b) is from 1 to 3, preferably from 1.5 to 2.5.

Leaching is generally carried out at a temperature ranging from 30 to 50° C., preferably from 32 to 37° C., in order to optimize the conversion of calcium sulfates.

The leaching step typically has a duration varying from 1 to 10 min, preferably from 1 to 5 min.

In step (c), calcium sulfates present in the solid residue are converted to soluble divalent alkali sulfates of formula X₂SO₄ (I) with X=Na, K, Li or Rb and insoluble calcium hydroxide.

The solid residue and the liquid phase obtained from the alkaline leaching are collected separately.

The solid residue obtained includes calcium hydroxide, REEs and other metallic elements.

Advantageously, the conversion rate is between 95 and 99.9%, preferably between 97.5 and 99.9% when the basic solution is a sodium hydroxide solution. The conversion rate T of sulfates in the alkaline leaching step (c) is defined as follows:

$$T = \frac{Ti * mi - Tf * mf}{Ti * mi} * 100$$

where mᵢ is the initial mass and Tᵢ is the calcium sulfate content of the ground residue before leaching obtained at the end of step (b) and m_{f} is the final mass and T_{f} is the calcium sulfate content of the residue obtained at the end of step (d).

The alkaline leaching step has the advantage of being fast. In addition, the small quantity of sodium hydroxide used allows the method to be environmentally friendly.

### Step (d)

Step (d) is a step of drying, grinding and sieving the solid residue obtained at the end of step (c).

The conditions of step (d) are as described in step (b).

The ground and sieved residue is typically in the form of particles having a size less than or equal to 400 μm, preferably ranging from 100 to 400 μm.

### Optional Step of Treating the Liquid Phase Obtained in Step (c)

The method can also comprise a step of neutralizing the liquid phase obtained at the end of step (c). Neutralization can be carried out by adding sulfuric acid to the liquid phase obtained at the end of step (c) to obtain a pH ranging from 5 to 8, preferentially from 5 to 7. This step makes it possible to convert the residual base present in the liquid phase (filtrate) (NaOH, KOH, LiOH or RbOH) to the corresponding alkali metal sulfate (X₂SO₄ (I) with X=Na, K, Li or Rb). This step makes it possible to obtain crystals of the corresponding alkali metal sulfate. The sulfate crystals obtained are collected.

Advantageously, the mineral base used during step (c) is sodium hydroxide and the sodium sulfate recovered has a purity by mass of 98% to 99.9%, preferentially 99.5% to 99.9%.

### Step (e):

Step (e) is a step of acid leaching the solid residue obtained at the end of step (d) with nitric acid. Acid leaching allows the extraction of nitric acid soluble elements from the solid residue.

The acid leaching step thus leads to the dissolution of REEs, calcium hydroxide and other metallic elements (e.g.: Ca, Al, Sr, Mg, etc.) present in the solid residue.

Preferentially, nitric acid is present in the form of a solution whose acid concentration is from 45 to 65% by weight, preferably from 50 to 60% by weight.

Nitric acid and calcium hydroxide are typically present in a stoichiometric ratio ranging from 0.5 to 2, advantageously equal to 1.

When nitric acid and calcium hydroxide are present in a stoichiometric ratio of less than 1, the dissolution of calcium hydroxide is not maximum.

When nitric acid and calcium hydroxide are present in a stoichiometric ratio of less than 1, the solubilization of rare earths is reduced.

Nitric acid allows a strong dissociation of the solid residue whose solubilization rate ranges from 80 to 99%, preferably from 85 to 95% of the initial mass of the solid residue.

The leaching step typically has a duration varying from 1 to 10 min, preferably from 1 to 5 min.

The solid residue and the liquid phase obtained at the end of acid leaching are collected separately, typically by centrifugation.

The liquid phase collected is rich in rare earths, calcium nitrates and other metallic elements.

### Step (f)

Step (f) is a step of precipitating calcium nitrate crystals from the liquid phase obtained at the end of step (e). Precipitation can be obtained by cooling, preferably to a temperature below 0° C. Cooling allows crystallization of calcium salts, in particular calcium nitrate tetrahydrate (Ca(NO₃)₂·4H₂O).

Seeding with crystals of calcium salts, for example calcium nitrate tetrahydrate, can be carried out in order to accelerate the crystallization rate.

The cooling of the liquid phase can be carried out at a temperature ranging from −20 to 0° C., preferably from −15 to −5° C., for a period typically ranging from 8 to 24 hours, advantageously from 16 hours to 24 hours, which makes it possible to obtain crystals of calcium nitrate tetrahydrate (solid residue).

The solid residue (e.g. calcium nitrate tetrahydrate) and the liquid phase obtained are collected separately. The separation can be carried out by vacuum filtration.

The liquid phase collected is rich in REEs, and other metallic elements.

### Optional Step of Washing the Calcium Nitrate Crystals Contained in the Solid Residue Obtained at the End of Step (f)

The solid residue collected (precipitated) may be washed with concentrated nitric acid.

The acid solution used for the washing step typically has an acid concentration ranging from 45 to 65% by weight, preferably from 50 to 60% by weight.

Washing removes residual traces of the liquid phase. Calcium nitrate tetrahydrate crystals are isolated. The separation can be carried out by vacuum filtration.

Step (g) makes it possible to precipitate and concentrate REEs.

### Step (c)

Step (g) is a step of adjusting the pH of the liquid phase obtained at the end of step (f) to a value of between 1 to 1.8 by adding a strong base. Adjusting the pH allows selective precipitation of the REEs contained in the liquid phase. The solid residue (precipitate) and the liquid phase obtained are collected separately. The separation can be carried out by centrifugation (for example, 3000 rpm for 15 min).

The strong base may be a solution of ammonium hydroxide, sodium hydroxide, potassium hydroxide, sodium carbonate, potassium carbonate or mixtures thereof, preferentially a solution of ammonium hydroxide or sodium hydroxide. The concentration of the strong base solution typically varies from 4 to 7 mol/L, preferably from 4 to 6 mol/L.

The pH is preferably adjusted to a value of 1 to 1.4.

The duration of step (g) generally varies from 10 to 60 min, preferably from 30 to 60 min.

### Step (h)

Step (h) is a step of drying the solid residue (precipitate) obtained at the end of step (g).

The dried solid residue can then be ground and sieved.

The conditions of step (h) are identical to those of step (b).

The solid residue is enriched in REEs.

The method according to the invention makes it possible to obtain solid residues typically having rare earth contents ranging from 4% to 6% by weight.

### Optional Step of Treating the Liquid Phase Obtained in Step (q)

The method may also comprise a step of adjusting the pH of the liquid phase obtained at the end of step (g) to a pH varying from 6 to 10, preferably from 7 to 10, by adding a strong base, the strong base preferentially being a solution of ammonium hydroxide or sodium hydroxide.

This step precipitates the residual and undesirable metallic elements present in the liquid phase, such as Fe, Al, etc. It makes it possible to obtain a purified solution of ammonium nitrate or sodium nitrate depending on the strong base used.

The same strong base solution used in step (g) can be used to adjust the pH.

### Optional Step of Treating the Solid Residue Obtained at the End of Step (h) Also Denoted Step (i):

The dried solid residue obtained at the end of step (h) may be ground, optionally sieved, and undergo the following treatment:
washing the ground solid residue, optionally sieved, with a polar solvent and collecting the solid residue obtained and the liquid phase obtained, then drying and grinding the solid residue to obtain a solid product containing rare earths,
or
calcining the ground solid residue, optionally sieved, at a temperature ranging from 700° C. to 1000° C. to obtain a solid product containing rare earths.

The ground solid residue, optionally sieved, can be washed with a polar solvent.

Advantageously, the polar solvent is water.

Advantageously, the polar solvent/solid residue mass ratio is from 5 to 15, preferably from 10 to 15.

The washing time typically varies from 15 minutes to 60 minutes, preferentially from 45 minutes to 60 minutes.

The washed solid residue is collected. The solid residue is then dried, ground and optionally sieved to obtain a solid product containing rare earths.

The conditions of the drying and grinding step are as described in step (b).

Alternatively, the ground solid residue, optionally sieved, can be calcined at a temperature ranging from 700° C. to 1000° C. to obtain a solid product containing rare earths. The calcining step advantageously eliminates traces of organic matter and residual water and therefore increases the rare earth content of the solid residue.

The solid residue can be calcined at a temperature of 800 to 900° C.

Advantageously, the duration of calcining is from 30 to 120 min, preferably from 45 to 60 min.

A minimum temperature of 700° C. allows the calcination of rare earth-enriched insolubles of the solid residue, while the application of a temperature above 1000° C. represents an unnecessary additional cost. A calcination temperature ranging from 700° C. to 1000° C. advantageously makes it possible to obtain complete calcination of the insolubles enriched in rare earths of the solid residue after a period ranging from 30 minutes to 2 hours.

This optional step of treatment of the solid residue obtained at the end of step (h) makes it possible to enrich said residue with REEs.

By implementing the optional step (i), the method according to the invention can make it possible to obtain solid residues typically having rare earth contents ranging from 5% to 25% by weight. This REE content advantageously ranges from 10% to 25% by weight when step (i) comprises a step of washing the solid residue obtained at the end of step (h) or ranges from 8% to 15% by weight when step (i) comprises calcining the solid residue obtained at the end of step (h).

In addition to rare earths, the method according to the invention makes it possible to isolate phosphorus, fluorine, silicon and calcium, as well as sulfur contained in PG and PASs, thus opening the way for recovering these elements.

The proposed method therefore makes it possible to recover by-products in the form of sodium fluorosilicates, divalent alkali metal sulfates, calcium nitrate tetrahydrate or sodium nitrate. These by-products are isolated. They can be purified and obtained in solid form or in solution.

In the method according to the invention, the separation of a liquid phase and a solid residue can be carried out by any separation technique known to the person skilled in the art, in particular by vacuum filtration or by centrifugation.

Centrifugation may be preferred when it is desired to recover the liquid phase.

Vacuum filtration may be preferred when it is desired to recover the solid phase.

Unless otherwise stated, the steps of the method are advantageously carried out at room temperature, in particular for reasons of cost.

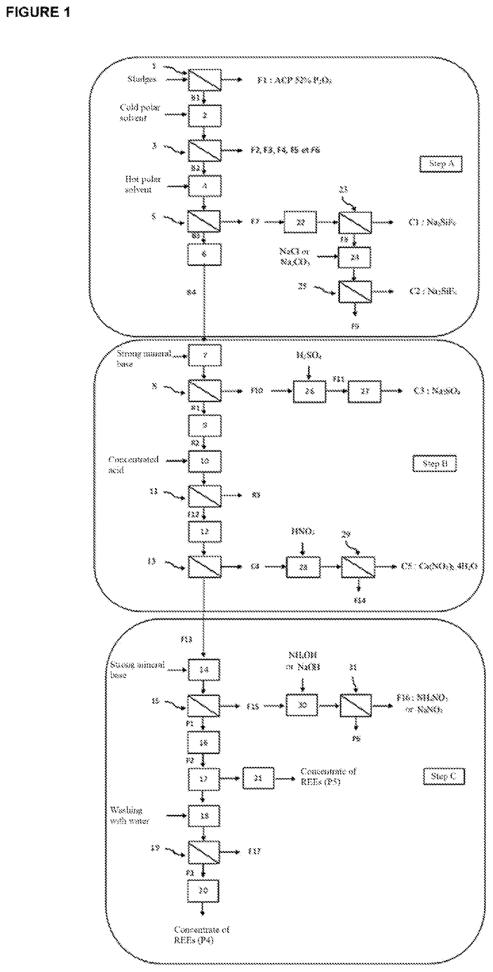

FIG. 1 is a schematic representation of an example of a method of the present invention implemented using phosphoric acid sludge. The person skilled in the art will be able to adapt the steps described to the phosphogypsum treatment.

With reference to FIG. 1, the method shown comprises 3 major steps:
A step (A) for reducing the content of soluble impurities in PASs. This step A comprises:
   separating 52% P₂O₅ acid (F1) and sludge, generally by centrifugation (1), typically carried out at 3000 rpm for 10 min;
   repeatedly washing the sludge (B1) with a protic polar aqueous solution at room temperature, so as to recover the P₂O₅, in a reactor (2);
   separating the sludge (B2) and filtrates F2, F3, F4, F5 and F6, typically by vacuum filtration (3);
   washing the sludge (B2) with a protic polar aqueous solution preheated in a reactor (4);
   separating the sludge (B3) and filtrate (F7), typically by vacuum filtration (5);
   drying the sludge (B3), for example at 80° C., followed by grinding and sieving, typically less than 250 mm (6);
   cooling the filtrate (F7) to room temperature in a tank (22);
   separating the crystals (C1) and filtrate (F8), typically by vacuum filtration (23);
   precipitating the crystals (C2) by attacking the filtrate (F8) with a sodium-based salt such as NaOH, NaCl, NaF, NaI or Na₂CO₃ in a reactor (24);
   separating the crystals (C2) and filtrate (F9) by filtration (25), typically under vacuum.
A step (B) of concentrating and leaching the REEs with a recovery of the sludge components and of the reagents used.

This step B comprises:
preparing a basic solution such as NaOH, KOH, LiOH, RbOH, or mixtures thereof in a reactor (7);
introducing the PASs (B4) and the basic solution into a reactor (8);
treating the mixture at a temperature generally above 35° C., typically for 5 min at a stirring speed of 500 rpm;
separating the filtrate (F10) and residue (R1), typically by vacuum filtration (8);
neutralizing the filtrate (F10), for example with sulfuric acid, in a reactor (26);
evaporating the neutralized filtrate (F11) in an oven (27), generally at 80° C.;
drying, typically at 80° C., followed by grinding (9) the residue (R1), to prepare the residue (R2);
preparing a nitric acid solution in a reactor (10);
introducing the residue (R2) and nitric acid solution into a reactor (10);
treating the mixture by mechanical stirring, typically at a speed of 500 rpm for 5 min;
separating the leachate (F12) and residue (R3) by centrifugation (11), typically at 3000 rpm for 15 min;
placing the leachate (F12) in a refrigerator (12) set at −10° C.;
seeding the leachate placed in the refrigerator, for example, with calcium nitrate tetrahydrate;
separating the leachate (F13) and crystals (C4) by filtration (13), typically under vacuum;
washing the crystals (C4) with nitric acid, for example, 50% by weight (28);
separating the filtrate (F14) and crystals (C5) by filtration (24), for example under vacuum;
A step (C) of precipitating and concentrating the REEs and purifying the leachate (F15).

This step (C) comprises:
adjusting the pH of the filtrate (F13) to pH=1.2 with a basic solution of NaOH, KOH, Na₂CO₃, K₂CO₃ or NH₄OH in a reactor (14);
separating the leachate (F15) and precipitate (P1) by centrifugation (15), typically at 3000 rpm for 15 min;
adjusting the pH of the filtrate (F15) by the NaOH, KOH, Na₂CO₃, K₂CO₃ or NH₄OH solution in a reactor (30);
separating the leachate (F16) and precipitate (P6), generally by centrifugation (31), typically at 3000 rpm for 15 min;
drying and grinding (16) the precipitate (P1) to prepare a solid (P2);
calcining the solid (P2) in a furnace (21), generally for one hour (1 h) at a temperature of 900° C.;
washing the precipitate (P2) in a reactor (18), generally with stirring at 300 rpm, with distilled water;
separating the leachate (F17) and precipitate (P3) typically by centrifugation (19) at 3000 rpm for 15 min;
drying and grinding (20) the precipitate (P3) to prepare a solid (P4).

As explained above, firstly (step (A)), the PASs are separated by centrifugation so as to obtain a solution (F1) containing 52% by weight of P₂O₅ and a residue rich in REEs (B1) of the gypsum type (CaSO₄) mixed with sodium fluorosilicate (Na₂SiF₆) and residual phosphorus pentoxide (P₂O₅). The sludge (B1) is washed in cascade with a polar solvent so as to recover more P₂O₅ and minimize the concentration of impurities while concentrating the REEs. For example, 5 washes can be carried out with water at room temperature with stirring at 300 rpm and a contact time of 5 min. A final washing can be carried out with hot water whose temperature varies from 80 to 90° C. with stirring at 300 rpm and a contact time of 10 min. The sludge (B3) is dried, ground and sieved to prepare a sludge (B4). Then, the hot filtrate is placed in a tank so as to promote cooling of the filtrate (F7) to room temperature. The purpose of cooling the filtrate is to generate crystallization/precipitation of crystals (C1) based on sodium fluorosilicate (Na₂SiF₆). Sodium chloride (NaCl) or sodium carbonate (Na₂CO₃) is then poured into the residual filtrate (F8) saturated with fluorine, silicates and sodium. The addition of the abovementioned salts promotes the precipitation of crystals (C2) based on sodium fluorosilicate (Na₂SiF₆).

Then, to carry out step (B), a basic solution of sodium hydroxide (NaOH), potassium hydroxide (KOH), lithium hydroxide (LiOH) or rubidium hydroxide (RbOH) is prepared. The solution is cooled to a temperature varying from 33 to 38° C. to ensure a high conversion of the sulfates, which constitute the major component of the sludge (B4). The residues (B4), rich in REEs, are poured into the basic solution to convert calcium sulfates to double alkali sulfate (X₂SO₄: X=Na, K, Li or Rb) (F10) and calcium hydroxide (R1) very rich in REEs and other metallic elements such as Al, Sr, Ba, Mg, etc. The filtrate (F10) is neutralized with a dilute sulfuric acid solution H₂SO₄. Neutralization is intended to promote the conversion of the residual base (NaOH, KOH, LiOH or RbOH) contained in the filtrate to double alkali sulfate (X₂SO₄: X=Na, K, Li or Rb), so as to prevent crystallization and mixing of the two products during drying. This neutralization step (26) makes it possible to obtain sodium sulfate crystals (C3).

The residues (R2) previously dried, ground and sieved to less than 400 μm are then solubilized in a nitric acid solution to dissolve the REEs, calcium and other metallic elements present in the residues (R2).

After solubilization, the filtrate, consisting mainly of solubilized calcium and nitrates, undergoes crystallization in a refrigerator to prepare crystals (C4) of calcium nitrate tetrahydrate (Ca(NO₃)₂·4H₂O) and a leachate (F13) rich in REEs and in metallic elements. After recovery of the leachate (F13), the crystals (C4) are washed. This step is carried out by pouring concentrated nitric acid onto the crystals (C4) to remove residual traces of leachate (F13). This promotes the purification of the final crystals (C5) of calcium nitrate tetrahydrate (Ca(NO₃)₂·4H₂O).

Finally, in step (C), the leachate (F13) undergoes a pH adjustment with a sodium hydroxide (NaOH) or ammonium hydroxide (NH₄OH) solution. The pH is controlled to precipitate the REEs. Then, the precipitate (P2), previously dried and ground, undergoes calcination or washing with water to further concentrate the REEs and obtain a washed precipitate (P4) or calcined precipitate (P5).

Finally, the leachate (F15), resulting from the pre-neutralization of the filtrate (F13) to a pH of 1.2, undergoes a post-neutralization at a defined pH to precipitate the residual metals in filtrate in order to further purify the liquid phase (F16) based on sodium nitrate or ammonium nitrate.

### REFERENCES

[1] G. Allaedini et P. Zhang, «Treatment of phosphoric acid sludge for rare earths recovery II: effect of sonication and flocculant solution temperature on settling rate», Separation Science and Technology, vol. 54, n^{o} 11, p. 1842-1852, juill. 2019, doi: 10.1080/01496395.2018.1536715
[2] A. Mahrou et al., «Rare Earth Elements Distribution During Phosphoric Acid Production», Mining, Metallurgy & Exploration, vol. 39, n^{o} 1, p. 161-167, févr. 2022, doi: 10.1007/s42461-021-00513-9
[3] G. G. Jang, A. Ladshaw, J. K. Keum, P. Zhang, et C. Tsouris, «Continuous-Flow Centrifugal Solid/Liquid Separation for the Recovery of Rare-Earth Elements Containing Particles from Phosphoric Acid Sludge», Ind. Eng. Chem. Res., vol. 59, n^{o} 50, p. 21901-21913, dec. 2020, doi: 10.1021/acs.iecr.0c04128
[4] WO2020067856A1
[5] Z. Wei et Z. Deng, «Research hotspots and trends of comprehensive utilization of phosphogypsum: Bibliometric analysis», Journal of Environmental Radioactivity, vol. 242, p. 106778, fevr. 2022, doi: 10.1016/j.jenvrad.2021.106778.
[6] CN111560521A
[7] CN112408452A
[8] CN110918251A
[9] U.S. Ser. No. 10/988,387B2
[10] RU2739409C1
[11] RU2258036C 1
[12] EP0419318A1
[13] S. Al-Thyabat et P. Zhang, «REE extraction from phosphoric acid, phosphoric acid sludge, and phosphogypsum», Mineral Processing and Extractive Metallurgy, vol. 124, n^{o} 3, p. 143-150, sept. 2015, doi: 10.1179/1743285515Y.0000000002
[14] S. A. Stern, J. T. Mullhaupt, et W. B. Kay, «The Physicochemical Properties of Pure Nitric Acid.», ACS Publications, 1 mai 2002. https://pubs.acs.org/doi/pdf/10.1021/cr60204a004

### EXAMPLES

The following examples of the implementation of a method according to the invention are given by way of illustration and should not be interpreted as limiting the scope of the invention.

To characterize the various raw materials and the residues and solutions obtained, physical and chemical analyses were carried out. In particular, X-ray crystallography (XRD) has been used to track the phase profile in solids. Scanning electron microscopy (SEM) was used to study their topography and morphology.

Energy-dispersive spectroscopy (EDS) was used for elemental chemical analysis of solids, inductively coupled plasma mass spectrometry (ICP-MS) was used for elemental analysis of rare earths in solids and liquids, and atomic absorption spectrometry (AAS) was used for elemental analysis of other elements in the solids and liquids.

The references given below (e.g.: B1, F1, etc.) refer to FIG. 1.

Unless otherwise indicated, the percentages indicated in the examples are percentages by weight.

### Example 1: Recovery of Phosphoric Acid Sludge and Preparation of a Solid Concentrate Rich in Rare Earths by Precipitation with Sodium Hydroxide

### Step (a)

The PASs are subjected to a centrifugation step for 10 min at a speed of rotation of 3000 rpm in order to obtain a solid residue (B1) and a liquid phase (F1).

Next, the solid residue (B1) is added to a volume of water with a liquid to solid mass ratio of 1 and is stirred mechanically at 300 rpm for 5 min at atmospheric pressure and at room temperature. After vacuum filtration and isolation of the liquid phase (F2), the solid residue obtained is added to a volume of water corresponding to a liquid to solid ratio of 2 and is stirred mechanically at 300 rpm for 5 min at atmospheric pressure and at room temperature. The liquid phase (F3) and the solid phase are then separated by vacuum filtration and washing is repeated 3 times. The liquid phases (F4) to (F6) and a solid residue (B2) are thus obtained.

Vacuum filtration of all the mixtures is carried out until a solid moisture content of 25 to 30% by weight is obtained.

The solid obtained (B2) is then added to a solution of water previously heated to 83° C. and the mixture is stirred mechanically at 300 rpm for 10 min, then the solid (B3) and the liquid (F7) are separated by vacuum filtration, the volume of water corresponding to 10 times the volume of dried solid. The objective of this step is to purify the sludge by removing the sodium fluorosilicate phase.

The filtrates separated from the solid after each washing are analyzed to determine the concentration of P₂O₅.

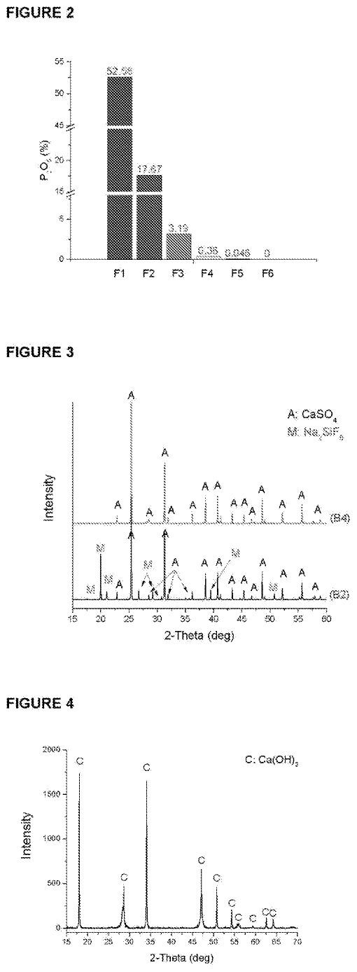

FIG. 2 shows the evolution of the phosphorus pentoxide concentration as a function of the number of cold washes.

The analysis results show that the concentration of P₂O₅ decreases from 52.58% by weight to 0% after the cold wash sequence, which implies the complete recovery of P₂O₅.

### Step (b)

The solid residue (B3) is dried, ground and sieved through 250 μm to obtain the solid residue (B4).

The results of the elemental analyses in PASs from the phosphoric workshop, Jorf Lasfar phosphate processing unit (Morocco) (B1) and in solids (B2) and (B4) are detailed in Table 1.

The residue (B4) obtained is 4 times more concentrated in REEs than the starting PASs. The mineralogical composition of the PASs (B1) and (B4) (Table 1) shows that the increase in the concentration of REEs in the PASs is accompanied by an increase in the concentration of calcium, sulfates, etc. and a decrease in the concentration of phosphorus pentoxide, fluorides and silicates.

The ICP results show that the REEs are concentrated in the cold pretreated PASs (B2). The solid is rich in REEs and other metallic elements and the filtrates are rich in P₂O₅.

TABLE 1
Mineralogical composition of different samples of phosphoric acid sludge

| | | | Cold washed sludge (B2) | | Hot washed, |
|---|---|---|---|---|---|
| | | Unwashed | After the | | dried, crushed |
| | mass | sludge | first cold | After the fifth | and sieved |
| | % | (B1) | wash | cold wash (B2) | sludge (B4) |
| CaO | % | 12.00 | 22.88 | 28.88 | 37.84 |
| SO₃ | % | 22.54 | 36.05 | 38.9 | 46.10 |
| F | % | 6.55 | 8.90 | 18.19 | 4.41 |
| P₂O₅ | % | 25.99 | 9.97 | 1.42 | 1.54 |
| SiO₂ | % | 4.58 | 6.31 | 9.63 | 3.44 |
| Na₂O | % | 5.21 | 6.47 | — | 4.19 |
| Fe₂O₃ | % | 0.21 | 0.06 | 0.00 | — |
| Na₂O | % | 3.35 | 6.61 | 7.42 | 0.68 |
| Al₂O₃ | % | 0.71 | 1.13 | 0.93 | 0.78 |
| K₂O | % | 0.06 | 0.04 | 0.01 | 0.00 |
| MgO | % | 0.90 | 0.59 | 0.23 | 0.02 |
| Sr | ppm | 648.56 | 1593.91 | 1953.00 | 2377.56 |
| Ni | ppm | 24.53 | 21.04 | 18.44 | 25.76 |
| Cr | ppm | 98.63 | 23.36 | 0.00 | 0.00 |
| Cu | ppm | 25.33 | 8.47 | 0.00 | 0.34 |
| Zn | ppm | 181.05 | 55.77 | 0.00 | 0.00 |
| Ba | ppm | 748.93 | 371.96 | 188.75 | 175.61 |
| V | ppm | 82.69 | 11.98 | 0.00 | 0.00 |
| As | ppm | 9.23 | 0.00 | 0.00 | 0.00 |
| Sc | ppm | 9.07 | 3.23 | 0.76 | 0.85 |
| Y | ppm | 438.26 | 1077.11 | 1430.47 | 1789.36 |
| La | ppm | 127.04 | 291.79 | 389.77 | 516.94 |
| Ce | ppm | 66.98 | 194.05 | 208.08 | 276.24 |
| Pr | ppm | 19.48 | 45.73 | 59.19 | 79.74 |
| Nd | ppm | 87.14 | 205.10 | 270.76 | 360.69 |
| Sm | ppm | 21.47 | 51.28 | 67.27 | 91.03 |
| Eu | ppm | 5.97 | 13.91 | 18.23 | 24.75 |
| Gd | ppm | 37.27 | 92.86 | 117.19 | 157.36 |
| Tb | ppm | 5.08 | 12.15 | 16.07 | 21.40 |
| Dy | ppm | 35.74 | 88.17 | 116.20 | 154.61 |
| Ho | ppm | 8.85 | 21.55 | 28.46 | 38.67 |
| Er | ppm | 29.72 | 74.16 | 98.11 | 132.91 |
| Tm | ppm | 4.57 | 11.01 | 14.50 | 19.77 |
| Yb | ppm | 28.83 | 68.64 | 91.09 | 122.81 |
| Lu | ppm | 4.05 | 8.68 | 11.42 | 15.35 |
| Σ of | ppm | 929.52 | 2259.41 | 2937.56 | 3802.49 |
| REEs | | | | | |

The main phases of the PASs are determined by XRD. The results of FIG. 3 show that the pretreated sludge (B2) is a mixture of 2 phases (CaSO₄ and Na₂SiF₆) whereas the sludge (B4) contains only the gypsum phase (CaSO₄). Hot washing therefore made it possible to remove the sodium fluorosilicates (Na₂SiF₆).

### Step (c):

The alkaline leaching of sludge (B4) is carried out as follows: 197.5 g of the sludge (B4) are poured into a volume of 500 mL of NaOH prepared beforehand by solubilizing 116.15 g of NaOH and cooling the solution to 35° C. The mixture is stirred at a speed of 500 rpm by a mechanical stirrer at different times, preferably for 5 min.

### Step (d):

After the vacuum filtration step, the residue (R1) is dried and ground to less than 250 μm to obtain a solid residue (R2). The residue (R2) is analyzed by ICP, XRD and chemical analysis to determine their chemical composition.

Table 2 shows the chemical composition of the residues (R2).

The results show that the residue (R2) is rich in REEs with a concentration greater than 6500 ppm. In addition, the yield of sulfate conversion and REEs concentration is 97.9% and 99.8%, respectively.

TABLE 2
Mineralogical composition of calcium hydroxides (R2)

| | | Residues (R2) | | | |
|---|---|---|---|---|---|
| CaO | % | 62.96 | Sc | ppm | 0.60 |
| SO₃ | % | 1.67 | Y | ppm | 2563.78 |
| F | % | 3.21 | La | ppm | 1024.94 |
| P₂O₅ | % | 2.49 | Ce | ppm | 562.80 |
| SiO₂ | % | 3.63 | Pr | ppm | 156.32 |
| Na₂O | % | 2.35 | Nd | ppm | 709.34 |
| Fe₂O₃ | % | — | Sm | ppm | 178.30 |
| Na₂O | % | 4.56 | Eu | ppm | 48.76 |
| Al₂O₃ | % | 1.24 | Go | ppm | 318.49 |
| K₂O | % | 0.02 | Tb | ppm | 43.07 |
| MgO | % | 0.03 | Dy | ppm | 311.97 |
| Pb | ppm | 0.00 | Ho | ppm | 77.07 |
| Sr | ppm | 3272.44 | Er | ppm | 265.16 |
| Ni | ppm | 32.46 | Tm | ppm | 39.26 |
| Ba | ppm | 814.89 | Yb | ppm | 243.80 |
| Cu | ppm | 1.46 | Lu | ppm | 30.24 |
| Zn | ppm | 11.47 | Σ of REEs | ppm | 6573.90 |
| Cr | ppm | 0.00 | | | |
| V | ppm | 0.00 | | | |
| As | ppm | 0.00 | | | |

XRD analysis of residue (R2) shows that the PASs were completely converted to calcium hydroxide, confirming the high conversion of calcium sulfates (FIG. 4).

### Step (e):

Residue R2 is subjected to acid leaching. 200 g of residue (R2) are added slowly to a volume of 490 mL of 50% by weight nitric acid solution. The mixture is subjected to mechanical stirring at a speed of 500 rpm for a variable duration, preferably of 5 min.

### Step (f):

After separation by centrifugation at 3000 rpm for 15 min, the filtrate (F12) is seeded with a few grains of calcium nitrate tetrahydrate and cooled to −10° C.

Next, the calcium nitrate crystals formed (C4) are separated by vacuum filtration to obtain a filtrate (F13).

The yield of the acid leaching (corresponding to the percentage of solid residue solubilized in step (e)) and the yield of the leachate concentration in REEs is 77.6 and 84.5%, respectively.

The results of the analyses of REEs and other metals in the different matrices are given in Table 3.

Crystals (C4) are washed with nitric acid at 50% by weight to prepare purified calcium nitrate tetrahydrate crystals (C5). The results of the analysis of the different fractions are presented in Table 3.

TABLE 3
Mineralogical composition of the filtrate (F12), (F13) and crystals (C5)

| | | Filtrate (F12) | Filtrate (F13) | | | Crystals (C5) |
|---|---|---|---|---|---|---|
| Fe₂O₃ | % | 0.002 | 0.004 | CaO | % | 19.860 |
| Al₂O₃ | % | 0.15 | 0.19 | SO₃ | % | 1.730 |
| K₂O | % | 0.00 | 0.01 | F | % | 0.160 |
| MgO | % | 0.01 | 0.02 | P₂O₅ | ppm | 100 |
| Cr | ppm | 4.17 | 9.11 | Zn | ppm | 0.00 |
| Cu | ppm | 1.72 | 3.35 | Pb | ppm | 0.241 |
| Zn | ppm | 11.31 | 20.83 | Co | ppm | 0.218 |
| V | ppm | 0.00 | 0.00 | Mn | ppm | 0.00 |
| Sr | ppm | 694.59 | 692.32 | Cr | ppm | 0.00 |
| Ni | ppm | 5.69 | 7.74 | K | ppm | 60.000 |
| As | ppm | 0.00 | 0.00 | Sc | ppm | 0.83 |
| Sc | ppm | 0.00 | 0.05 | Y | ppm | 50.73 |
| Y | ppm | 478.28 | 694.76 | La | ppm | 49.31 |
| La | ppm | 168.64 | 201.48 | Ce | ppm | 31.48 |
| Ce | ppm | 85.15 | 109.66 | Pr | ppm | 5.95 |
| Pr | ppm | 27.32 | 35.35 | Nd | ppm | 22.46 |
| Nd | ppm | 98.65 | 155.35 | Sm | ppm | 4.26 |
| Sm | ppm | 29.56 | 40.71 | Eu | ppm | 1.17 |
| Eu | ppm | 9.02 | 12.61 | Gd | ppm | 11.31 |
| Gd | ppm | 56.20 | 77.57 | Tb | ppm | 0.67 |
| Tb | ppm | 7.79 | 11.15 | Dy | ppm | 4.53 |
| Dy | ppm | 53.58 | 72.07 | Ho | ppm | 1.02 |
| Ho | ppm | 12.59 | 18.15 | Er | ppm | 3.32 |
| Er | ppm | 42.74 | 61.35 | Tm | ppm | 0.43 |
| Tm | ppm | 6.72 | 9.66 | Yb | ppm | 2.30 |
| Yb | ppm | 39.73 | 52.50 | Lu | ppm | 0.25 |
| Lu | ppm | 4.99 | 7.16 | Σ of REEs | ppm | 190.01 |
| Σ of REEs | ppm | 1121.03 | 1559.58 | | | |

### Step (g):

The filtrate (F13), consisting of a concentrate of REEs dissolved in a medium containing predominantly nitrates, undergoes a pH adjustment. A volume of filtrate of 150 mL is treated with sodium hydroxide at a concentration of 5 mol/L to adjust the pH to 1.2. The whole is stirred at 300 rpm by a magnetic stirrer for a period of one (1) hour.

### Step (h):

After recovery of the precipitate (P1) by centrifugation at 3000 rpm for 15 min, it is dried and ground to give the solid residue (P2) containing the REEs. The mass content of REEs of the solid residue P2 is 4.8%.

The filtrate (F15) is treated to adjust the pH to 8.78 (F16) with sodium hydroxide to precipitate residual metals and obtain a purified sodium nitrate solution.

### Optional Step (i):

The solid residue (P2) is washed with water at a stirring speed of 300 rpm for a period of one (1) hour for a solid to liquid mass ratio of 10, then the residual solid (P3) is isolated by centrifugation at 3000 rpm for 15 min.

The solid (P3) undergoes drying at 80° C. followed by grinding to prepare a solid (P4).

According to a variant of the method, the solid residue P2 undergoes a calcination step at 900° C. for one hour in order to obtain the residue (P5).

The results of the analyses of REEs and other mineral components are given in Table 4.

The ICP analysis results shown in Table 4 show the effectiveness of the cascade method in selectively precipitating REEs in the precipitate (P1) and purification of the filtrate (F14). The precipitates (P4) and (P5) are advantageously rich in REEs and reach a mass concentration of 19% and 9.4%, respectively.

TABLE 4
Mineralogical composition of precipitates from the PAS filtrate
neutralized with sodium hydroxide/

| | | Filtrate | Precipitate | Precipitate | Precipitate |
|---|---|---|---|---|---|
| | | (F16) | (P2) | (P4) | (P5) |
| Fe₂O₃ | % | 0.00 | 0.45 | 2.07 | 0.91 |
| Al₂O₃ | % | 0.00 | 3.14 | 12.06 | 6.35 |
| K₂O | % | 0.01 | 0.06 | 0.08 | 0.21 |
| MgO | % | 0.00 | 0.02 | 0.10 | 0.06 |
| Cr | ppm | 0.00 | 38.54 | 255.44 | 125.32 |
| Cu | ppm | 0.00 | 38.55 | 158.71 | 82.05 |
| Zn | ppm | 0.00 | 0.00 | 0.00 | 0.00 |
| Ba | ppm | 584.15 | OOR | OOR | 14762.28 |
| V | ppm | 0.00 | 0.00 | 0.00 | 0.00 |
| Sr | ppm | 383.30 | 2210.09 | 4454.08 | 3974.92 |
| Ni | ppm | 0.07 | 238.28 | 996.04 | 451.68 |
| As | ppm | 1.14 | 0.00 | 0.00 | 0.00 |
| Sc | ppm | 0.02 | 1.26 | 5.26 | 2.77 |
| Y | ppm | 0.75 | 27148.51 | 105159.61 | 53031.89 |
| La | ppm | 0.42 | 4241.89 | 21452.32 | 9463.86 |
| Ce | ppm | 0.26 | 2675.48 | 10471.67 | 5110.59 |
| Pr | ppm | 0.05 | 894.12 | 2947.04 | 1464.88 |
| Nd | ppm | 0.21 | 3202.74 | 12320.44 | 6213.54 |
| Sm | ppm | 0.05 | 1081.17 | 3288.50 | 1628.07 |
| Eu | ppm | 0.03 | 337.20 | 1497.76 | 718.75 |
| Gd | ppm | 0.11 | 1561.96 | 6103.01 | 3035.53 |
| Tb | ppm | 0.01 | 304.24 | 1383.99 | 679.10 |
| Dy | ppm | 0.08 | 1898.38 | 7326.05 | 3654.93 |
| Ho | ppm | 0.02 | 546.86 | 2296.28 | 1161.48 |
| Er | ppm | 0.07 | 1838.63 | 7164.98 | 3556.15 |
| Tm | ppm | 0.01 | 294.83 | 1194.40 | 615.63 |
| Yb | ppm | 0.06 | 1879.89 | 7237.44 | 3595.51 |
| Lu | ppm | 0.01 | 225.34 | 910.70 | 466.22 |
| Σ of | ppm | 2.17 | 48132.52 | 190759.45 | 94398.90 |
| REEs | | | | | |

OOR: out of range

Additional Steps in the Recovery of by-Products

As described above, the method may comprise steps allowing the by-products to be recovered, for example to obtain crystals of purified calcium nitrate tetrahydrate (see step (f) above) or to obtain a purified sodium nitrate solution (see step (h) above).

Other by-products can also be recovered.
treatment of the liquid phase obtained at the end of step (a) to recover the sodium fluorosilicates

The filtrate from the hot washing (F7) obtained during step (a) is cooled to room temperature to ensure supersaturation of the medium with sodium fluorosilicates, which promotes their precipitation. The solid phase is separated from the liquid phase (F8) by vacuum filtration and is then dried, ground and analyzed by XRD. The analysis (FIG. 5) shows that the solid residue contains only sodium fluorosilicates (C1).

A volume of filtrate of 1 L saturated with sodium fluorosilicates (F8) is used to precipitate the residual sodium fluorosilicates from the step above by adding a volume of 50 mL of NaCl solution with a concentration of 3 mol/L.

According to a variant of the method, precipitation by adding 30 mL of Na₂CO₃ solution with a concentration of 1.5 mol/L can be used to precipitate Na₂SiF₆. The reaction time adopted is 1 h and the stirring speed is 500 rpm.

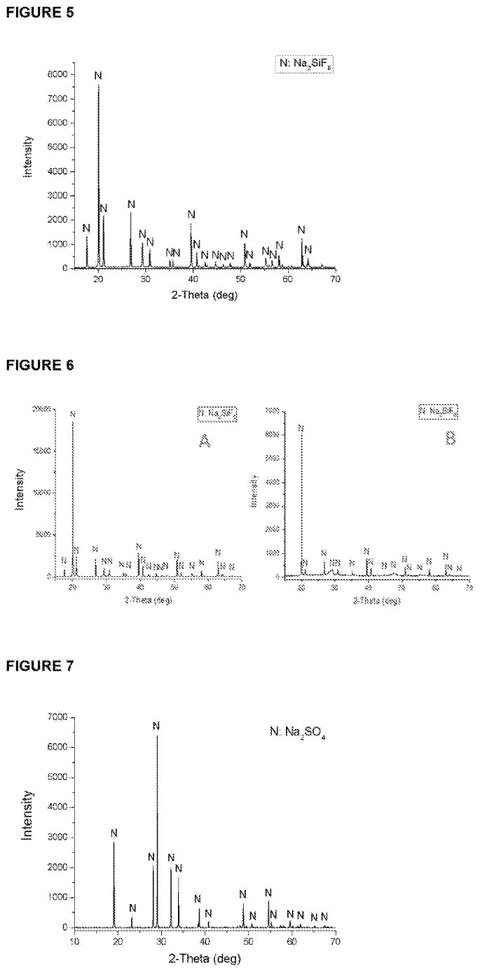

X-ray diffraction analysis (FIG. 6) shows that the precipitate contains only the sodium fluorosilicate (C2) phase. The chemical analyses made it possible to determine the purity of the products formed. The Na₂SiF₆ resulting from the supersaturation and the addition of NaCl are pure (>99%), however, the Na₂SiF₆ resulting from the addition of Na₂CO₃ is of a lower quality (~60%).
treatment of the liquid phase obtained at the end of step (c) to recover the sodium sulfate

The filtrate (F10) obtained at the end of step (d) is neutralized with a solution of H₂SO₄ to a pH varying from 6 to 6.5 in order to eliminate traces of residual sodium hydroxide (NaOH). The solution is neutralized and dried at 80° C. and then the solid residue is ground. XRD analysis (FIG. 7) shows that the residue obtained is of sodium sulfate (C3) type.

The elemental analysis in Table 5 shows that sodium sulfate (C3) crystals are weakly contaminated with metallic elements. The purity of the product obtained is 99.7%.

TABLE 5
Mineralogical composition of sodium sulfates
Crystals (C3)

| | | | | | | | | |
|---|---|---|---|---|---|---|---|---|
| SO₃ | % | 56.6 | K | ppm | 340.00 | Gd | ppm | 0.15 |
| F | % | 0.23 | Sc | ppm | 0.85 | Tb | ppm | 0.03 |
| P₂O₅ | % | 0.00 | Y | ppm | 1.02 | Dy | ppm | 0.13 |
| Na₂O | % | 43.1 | La | ppm | 0.54 | Hc | ppm | 0.04 |
| Zn | ppm | 0.00 | Ce | ppm | 0.28 | Er | ppm | 0.10 |
| Pb | ppm | 0.126 | Pr | ppm | 0.07 | Tm | ppm | 0.02 |
| Co | ppm | 0.00 | Nd | ppm | 0.36 | Yb | ppm | 0.07 |
| Mn | ppm | 0.00 | Sm | ppm | 0.09 | Lu | ppm | 0.02 |
| Cr | ppm | 0.00 | Eu | ppm | 0.03 | Σ of REEs | ppm | 3.78 |

### Example 2: Recovery of Phosphoric Acid Sludge and Preparation of a Solid Concentrate Rich in REEs by Precipitation with Ammonium Hydroxide

The method for treating the PASs is identical to that of Example 1 except for the strong base used in step (g), which in Example 2 is an ammonium hydroxide solution.

### Step (c)

A volume of filtrate (F13) of 150 mL is neutralized with a 5 mol/L ammonium hydroxide solution to adjust the pH to 1.2. The whole is stirred at 300 rpm by a magnetic stirrer for a period of one (1) hour. After recovery of the precipitate (P1) by centrifugation at 3000 rpm for 15 min, the filtrate undergoes further neutralization to pH 7.45 using the ammonium hydroxide solution prepared beforehand. Next, the solid is separated from the filtrate by centrifugation.

### Step (h) and Step (i)

The solid residue (P2) obtained after drying, grinding and sieving the precipitate (P1) undergoes an optional washing step or an optional calcination step.

The solid residue (P2) has a mass content of REEs of 4.3%.

Washing is carried out with water at a stirring speed of 300 rpm for a period of one (1) hour for a solid to liquid ratio of 10. Subsequently, the solid (P3) highly concentrated in REEs was recovered by centrifugation at 3000 rpm for 15 min and then underwent drying and grinding to obtain the REE concentrate (P4).

The precipitate (P2) is calcined at 900° C. for one hour, and the precipitate obtained is named (P5). The results of the analyses of REEs and other mineral components are given in Table 6. The concentration of REEs in the precipitate P4 and P5, after carrying out the optional step (i), is 19.2 and 12.3%, respectively.

TABLE 6
Mineralogical composition of precipitates from the PAS
filtrate neutralized with ammonium hydroxide

| | | Filtrate | Precipitate | Precipitate | Precipitate |
|---|---|---|---|---|---|
| | | (F16) | (P2) | (P4) | (P5) |
| Fe₂O₃ | % | 0.00 | 1.48 | 6.56 | 3.87 |
| Na₂O | % | OOR | 3.36 | 1.62 | OOR |
| Al₂O₃ | % | 0.00 | 2.24 | 9.14 | 6.10 |
| K₂O | % | 0.00 | 0.07 | 0.09 | 0.20 |
| MgO | % | 0.01 | 0.00 | 0.00 | 0.04 |
| Cr | ppm | 0.00 | 77.79 | 457.89 | 315.48 |
| Cu | ppm | 0.00 | 31.74 | 154.02 | 116.20 |
| Zn | ppm | 0.00 | 0.00 | 0.00 | 0.00 |
| Ba | ppm | OOR | OOR | OOR | OOR |
| V | ppm | 0.00 | 0.00 | 0.00 | 0.00 |
| Sr | ppm | 362.56 | 2598.17 | 5399.64 | 6431.32 |
| Ni | ppm | 1.76 | 191.23 | 851.26 | 509.70 |
| As | ppm | 0.65 | 0.00 | 0.00 | 0.00 |
| Sc | ppm | 0.03 | 2.71 | 9.27 | 0.93 |
| Y | ppm | 0.50 | 25455.26 | 109666.00 | 75313.81 |
| La | ppm | 0.48 | 3734.18 | 29629.26 | 12333.78 |
| Ce | ppm | 0.27 | 1985.74 | 8190.79 | 5805.19 |
| Pr | ppm | 0.03 | 645.95 | 2811.13 | 1702.22 |
| Nd | ppm | 0.12 | 2185.16 | 9438.26 | 6541.03 |
| Sm | ppm | 0.03 | 773.87 | 3228.09 | 2113.27 |
| Eu | ppm | 0.04 | 248.55 | 1015.43 | 672.08 |
| Gd | ppm | 0.08 | 1602.66 | 4949.63 | 3421.23 |
| Tb | ppm | 0.01 | 249.54 | 1003.01 | 610.49 |
| Dy | ppm | 0.05 | 1726.18 | 6098.67 | 4171.69 |
| Ho | ppm | 0.01 | 439.07 | 1790.55 | 1122.89 |
| Er | ppm | 0.04 | 1578.54 | 6094.73 | 4160.28 |
| Tm | ppm | 0.01 | 268.94 | 990.05 | 634.74 |
| Yb | ppm | 0.04 | 1626.30 | 6560.82 | 4495.88 |
| Lu | ppm | 0.01 | 211.36 | 790.59 | 507.67 |
| Σ of REEs | ppm | 1.72 | 42734.01 | 192266.28 | 123607.17 |

### Example 3: Recovery of Phosphoric Acid Sludge and Preparation of a Solid Concentrate Rich in REEs by Precipitation with Sodium Hydroxide

In this example, the same PAS treatment method described in Example 1 is implemented, except for the number of cold washes during step a), which in this example is equal to 3.

The protocol consists of pretreating the PASs by centrifugation at 3000 rpm for 10 min. Next, the solid phase obtained (B1) is subjected to washing with a volume of water corresponding to a solid to liquid ratio of 1 for 5 min at atmospheric pressure and room temperature. After vacuum filtration, the solid phase, containing a moisture content varying from 25 to 30%, is added to a volume of water corresponding to a solid to liquid ratio of 2 with mechanical stirring for 5 min at atmospheric pressure and room temperature. Then the liquid phase and the solid phase are separated by vacuum filtration and the last washing is repeated once.

The mineralogical composition of the solid residue (P2) obtained at the end of step h) and of the solid residue (P4) obtained at the end of step i) according to the variant of the method with washing of the solid residue P2 is detailed in Table 7.

The solid residue (P2) according to the invention has a mass content of REEs of 5.4%.

By implementing the optional step (i), the REE content of the solid product is 21.3%.

TABLE 7
Mineralogical composition of precipitates from the PAS filtrate
neutralized with sodium hydroxide

| | | Precipitate | | | | Precipitate | |
|---|---|---|---|---|---|---|---|
| | | (P2) | Precipitate (P4) | | | (P2) | Precipitate (P4) |
| Fe₂O₃ | % | 0.03 | 0.24 | La | ppm | 6518.31 | 27300.74 |
| Na₂O | % | 16.07 | 6.02 | Ce | ppm | 4064.03 | 16383.09 |
| Al₂O₃ | % | 5.00 | 19.46 | Pr | ppm | 1186.61 | 4987.48 |
| K₂O | % | 0.00 | 0.00 | Nd | ppm | 5139.28 | 20981.98 |
| MgO | % | 0.04 | 0.10 | Sm | ppm | 1366.83 | 5183.01 |
| Cr | ppm | 0.00 | 0.00 | Eu | ppm | 371.69 | 1622.82 |
| Cu | ppm | 24.08 | 118.92 | Gd | ppm | 2433.36 | 9152.49 |
| Zn | ppm | 114.61 | 155.98 | Tb | ppm | 341.69 | 1530.25 |
| Ba | ppm | 6447.38 | 19062.61 | Dy | ppm | 2558.35 | 9544.93 |
| V | ppm | 0.00 | 0.00 | Ho | ppm | 641.08 | 2700.14 |
| Sr | ppm | 1821.64 | 2117.71 | Er | ppm | 2217.78 | 8197.03 |
| Ni | ppm | 392.10 | 1645.27 | Tm | ppm | 313.01 | 1327.02 |
| As | ppm | 0.00 | 0.00 | Yb | ppm | 1933.29 | 7338.60 |
| Sc | ppm | 3.38 | 9.63 | Lu | ppm | 229.13 | 912.90 |
| Y | ppm | 25173.82 | 96107.58 | Σ of REEs | ppm | 54491.64 | 213279.69 |

### Example 4: Recovery of Phosphoric Acid Sludge and Preparation of a Solid Concentrate Rich in REEs by Precipitation with Ammonium Hydroxide

In this example, the same PAS treatment method described in Example 2 is implemented, except for the number of cold washes during step a), which in this example is equal to 3. The 3 washing steps are as described in Example 3.

The mineralogical composition of the solid residue (P2) obtained at the end of step h) and of the solid residue (P4) obtained at the end of step i) according to the variant of the method with washing of the solid residue P2 is detailed in Table 8.

The solid residue (P2) according to the invention has a mass content of REEs of 4.6%.

By implementing the optional step (i), the REE concentration in the precipitate P4 is 18.66%.

TABLE 8
Mineralogical composition of precipitates from the PAS
filtrate neutralized with ammonium hydroxide

| | | Precipitate | | | | Precipitate | |
|---|---|---|---|---|---|---|---|
| | | (P2) | Precipitate (P4) | | | (P2) | Precipitate (P4) |
| Fe₂O₃ | % | — | 0.15 | La | ppm | 4342.80 | 27625.25 |
| Na₂O | % | 2.26 | 3.03 | Ce | ppm | 2305.85 | 8320.12 |
| Al₂O₃ | % | 6.03 | 12.78 | Pr | ppm | 663.61 | 2779.15 |
| K₂O | % | 0.12 | 0.04 | Nd | ppm | 2882.55 | 9537.11 |
| MgO | % | 0.09 | 0.20 | Sm | ppm | 798.12 | 3111.10 |
| Cr | ppm | 0.00 | 0.00 | Eu | ppm | 233.98 | 998.98 |
| Cu | ppm | 17.13 | 44.15 | Gd | ppm | 1547.27 | 4876.56 |
| Zn | ppm | 50.82 | 0.00 | Tb | ppm | 236.34 | 1198.86 |
| Ba | ppm | 14463.73 | 28549.92 | Dy | ppm | 1829.47 | 6200.48 |
| V | ppm | 0.00 | 0.00 | Ho | ppm | 469.43 | 1670.14 |
| Sr | ppm | 2129.90 | 2823.88 | Er | ppm | 1689.84 | 6550.19 |
| Ni | ppm | 265.00 | 651.54 | Tm | ppm | 265.09 | 899.35 |
| As | ppm | 0.00 | 0.00 | Yb | ppm | 1697.99 | 6430.71 |
| Sc | ppm | 0.78 | 8.97 | Lu | ppm | 210.36 | 798.57 |
| Y | ppm | 27051.03 | 105662.13 | Σ of REEs | ppm | 46224.50 | 186667.67 |

1. A method for treating phosphogypsum or phosphoric acid sludge allowing the recovery of rare earths, the method comprising the following successive steps:
(a) treating the phosphogypsum or phosphoric acid sludge, respectively, according to the following steps (a1) or (a2):
(a1) washing the phosphogypsum with a polar solvent and collecting the solid residue obtained; or
(a2) separating the phosphoric acid sludge into a liquid phase and a solid residue and separately collecting the resulting solid residue and the resulting liquid phase;
washing the solid residue obtained at the end of the treatment with a polar solvent at room temperature and separately collecting the solid residue obtained and the liquid phase obtained; and
washing the solid residue obtained at the end of washing with a hot polar solvent and collecting the solid residue obtained and the liquid phase obtained;
(b) drying, grinding and sieving the solid residue obtained at the end of step (a);
(c) alkaline leaching the solid residue obtained at the end of step (b) with a strong mineral base, and collecting the solid residue obtained and the liquid phase obtained;
(d) drying, grinding and sieving the solid residue obtained at the end of step (c);
(e) acid leaching the solid residue obtained at the end of step (d) with nitric acid and collecting the solid residue obtained and the liquid phase obtained;
(f) precipitating calcium nitrate crystals from the liquid phase obtained at the end of step (e) and collecting the solid residue and the liquid phase obtained;
(g) adjusting the pH of the liquid phase obtained at the end of step (f) to a value of between 1 to 1.8 by adding a strong base and collecting the solid residue obtained and the liquid phase obtained;
(h) drying the solid residue obtained at the end of step (g) to obtain a solid product containing rare earths.

2. The method according to claim 1, wherein the polar solvent of step (a) is water, methanol, ethanol, acetone, an ether or mixtures thereof.

3. The method according to claim 1 wherein the strong inorganic base of step (c) is a solution of sodium hydroxide, potassium hydroxide, lithium hydroxide or rubidium hydroxide.

4. The method according to claim 1 wherein step (c) is carried out at a temperature ranging from 30 to 50° C.

5. The method according to claim 1 wherein the strong base of step (g) is a solution of ammonium hydroxide, sodium hydroxide, potassium hydroxide, sodium carbonate, potassium carbonate or mixtures thereof.

6. The method according to claim 1, further comprising a step of precipitating the fluorosilicate salts contained in the liquid phase obtained at the end of step (a2) and collecting the salts obtained.

7. The method according to claim 1, further comprising a step of neutralizing the liquid phase obtained at the end of step (c) and of collecting the crystals of sodium sulfates obtained.

8. The method according to claim 1, wherein the precipitation of the calcium nitrate crystals in step (f) is carried out by cooling the liquid phase, or by cooling the liquid phase and seeding the liquid phase.

9. The method according to claim 1, further comprising a step of washing with nitric acid the solid residue obtained at the end of step (f) and collecting the solid residue obtained comprising crystals of calcium nitrate tetrahydrate.

10. The method according to claim 1, further comprising a step of adjusting the pH of the liquid phase obtained at the end of step (g) to a pH varying from 6 to 10 by adding a strong base to obtain a solution of ammonium nitrate or sodium nitrate.

11. The method according to claim 1 further comprising a step (i) comprising grinding, or grinding and sieving, the dried solid residue obtained at the end of step (h) and:
washing the ground or ground/sieved solid residue, with a polar solvent and collecting the solid residue obtained and the liquid phase obtained, then drying and grinding the solid residue to obtain a solid product containing rare earths,
or
calcining the ground or ground/sieved solid residue, at a temperature ranging from 700° C. to 1000° C. to obtain a solid product containing rare earths.

12. The method according to claim 2, wherein the polar solvent of step (a) is water.

13. The method according to claim 3, wherein the strong inorganic base of step (c) is a solution of sodium hydroxide.

14. The method according to claim 4, wherein step (c) is carried out at a temperature ranging from 32 to 37° C.

15. The method according to claim 5, wherein the strong base of step (g) is a solution of ammonium hydroxide or sodium hydroxide.

16. The method according to claim 6, wherein the step of precipitating the fluorosilicate salts contained in the liquid phase obtained at the end of step (a2) is carried out by cooling and adding sodium chloride (NaCl) or sodium carbonate.

17. The method according to claim 7, wherein the step of neutralizing the liquid phase obtained at the end of step (c) is carried out by adding sulfuric acid to the liquid phase obtained at the end of step (c) to obtain a pH ranging from 5 to 8.

18. The method according to claim 17, wherein the pH ranges from 5 to 7.

19. The method according to claim 10, wherein the strong base is a solution of ammonium hydroxide or sodium hydroxide.
